(19) United States
(12) Patent Application Publication
(10) Pub. No.: US 2004/0215745 A1
(43) Pub. Date: Oct. 28, 2004

(54) Data warehouse system providing remote queries for multiple providers

(76) Inventor: Chih-Hung Chien, Taoyuan (TW)

Correspondence Address: BIRCH STEWART KOLASCH & BIRCH, PO BOX 747, FALLS CHURCH, VA, 22040-0747, US

(21) Appl. No.: 10/409,148

(22) Filed: Apr. 9, 2003

(51) Int. Cl. G06F 15/16

(52) U.S. Cl. 709/219; 709/246

(57) ABSTRACT

Data warehouse system is a system providing remote queries for multiple providers and transmitting data via World Wide Web. This system has three parts: the client, the provider and the virtual data processor. The client (respectively, the provider) transmits the data into the virtual data processor, and the provider (respectively, the client) retrieves the data from the virtual data processor unit when the data are required. The client (respectively, the provider) can also transmit the data directly to the provider (respectively, the client) via the virtual data processor. Since the client contacts with only one corresponding unit of the provider, the gap between the client and provider is reduced. It also increases operation efficiency and reduces costs.

### BACKGROUND OF THE INVENTION

1. Field of Invention

This invention is related to a data warehouse system built on World Wide Web, and especially a system to provide remote queries for multiple providers.

2. Related Art

In the past, data were transmitted manually between the client and the provider. So more manpower was required and data were received after a long time. Because the client and the provider used different software, the client (respectively, the provider) should re-key the received data from the provider (respectively, the client) before using them. Since the inventories on both parties were not transparent, both parties required more inventories. In addition, the system complexity increased, since one client should contact with many corresponding units of the provider.

Because of this, supply chain management is advocated to make the processes between the client and provider more effective, reduce the costs and increase the operation efficiency. Thus, more companies endeavor to develop variant tools to achieve the advantages above.

The use of data warehouse system can achieve the mentioned advantages. A distributed data warehouse and resource management system was proposed in U.S. Pat. No. 6,178,418 B1 which describes a different approach of data query and retrieval. However, although this approach can increase the operation efficiency and reduce the cost, it cannot avoid the case that the client should contact with multiple corresponding units of the provider.

Therefore, it is necessary to design a data warehouse system so the client has to contact with only one corresponding unit of the provider.

### SUMMARY OF THE INVENTION

This invention is related to a data warehouse system providing remote queries for multiple providers and transmits data via World Wide Web. The system consists of three parts: the client, the provider and the virtual data processor. The client (respectively, the provider) can transmit the data into the virtual data processor, and the provider (respectively, the client) retrieves the data from the virtual data processor when he or she requires the data. The client (respectively, the provider) can also transmit the data directly to the provider (respectively, the client) via the virtual data processor. Since the client needs to contact with only one corresponding unit of the provider, the gap between the client and provider is reduced. It also increases operation efficiency and reduces costs. When the data formats of the both parties are different, the data need to be transformed before used by the client and provider.

Detailed contents and concepts of the invention are described below.

### BRIEF DESCRIPTION OF THE DRAWINGS

The present invention will become more fully understood from the detailed description given in the illustration below only, and thus are not limitative of the present invention:

FIG. 1 is a brief system architecture of this invention.

FIG. 2 is a detailed system architecture of this invention.

FIG. 3 is another detailed system architecture of this invention.

FIG. 4 is another detailed system architecture of this invention.

### DETAILED DESCRIPTION OF THE INVENTION

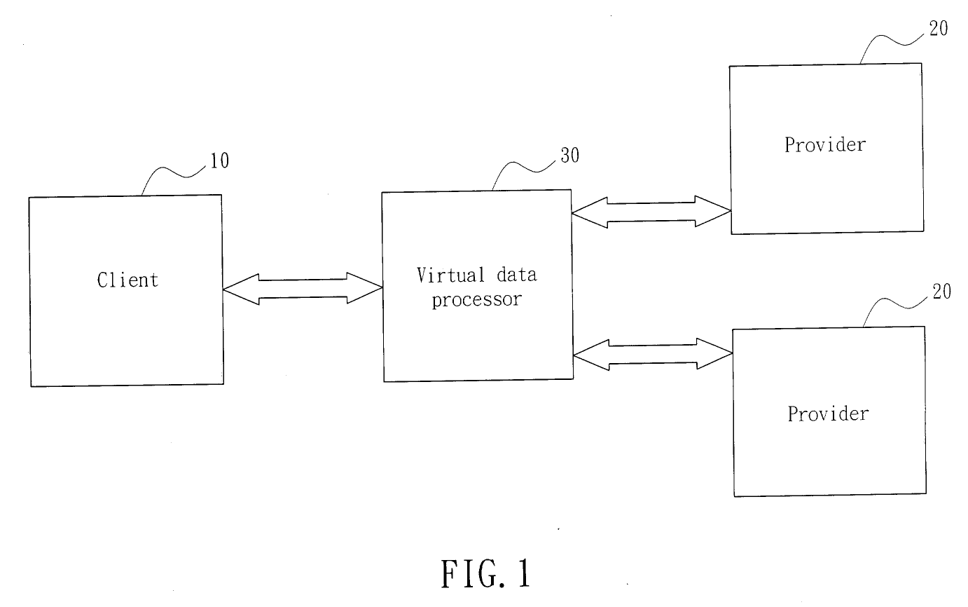

As shown in FIG. 1, the proposed system transmits the data via World Wide Web and comprises the client 10, multiple providers 20 and a virtual data processor 30. The client 10 and the provider 20 both connect with the virtual data processor 30 and exchange data with each other via the virtual data processor 30. The client's 10 and the provider's 20 data can be stored in the virtual data processor 30.

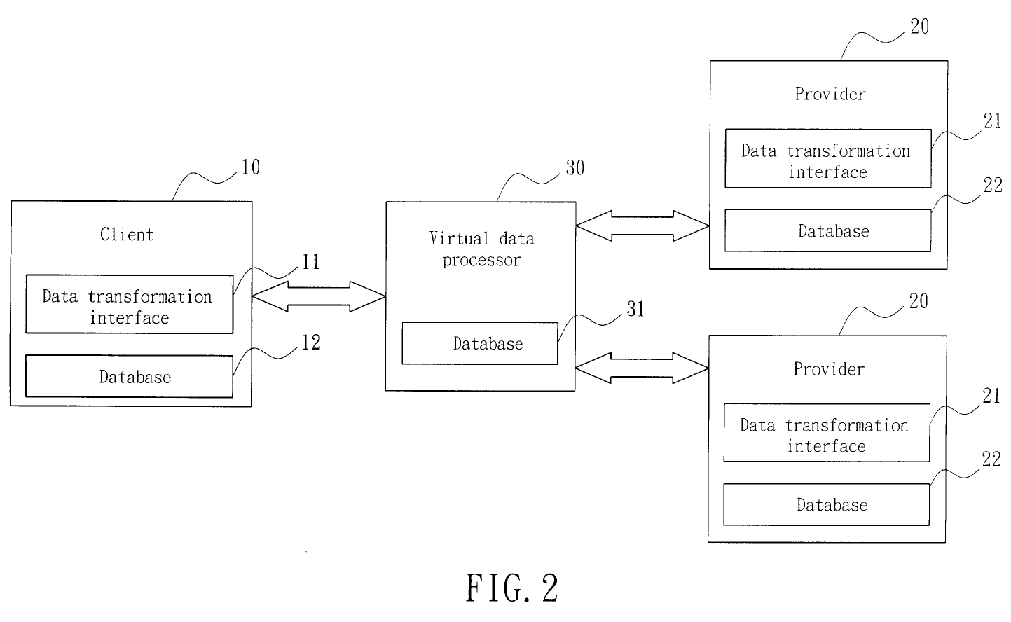

As shown in FIG. 2, the proposed data warehouse system, providing remote queries for multiple providers, transmits the data via World Wide Web and comprises the client 10, multiple providers 20 and a virtual data processor 30. The client 10 and the provider 20 both connect with the virtual data processor 30 and exchange data with each other via the virtual data processor 30. The client's 10 and the provider's 20 data can be stored in the virtual data processor 30. The client (respectively, the provider) has a data transformation interface 11 (respectively, 21) to transform the data formats and a databases 12 (respectively, 22) to store data. In addition, the virtual data processor also has a database 31 to store data.

Generally speaking, the client 10 and the provider 20 usually have different software. Hence, when the client 10 directly transmits data to the provider 20 without data format transformation, the provider 20 can't use the data. The provider should re-key the data in order to use them. In the invention, when the client 10 wants to send some data from his or her database 20 to the provider 20, the client transforms the data format by the data transformation interface 11 (i.e., transforms the data format into the one used by the virtual data processor 30) and sends the transformed data to the virtual data processor 30. The virtual data processor 30 stores the data in the database 31 and sends the data to the data transformation interface 21 in the provider. The transformation interface 21 transforms the data formation into the one used by the provider 20 and sends the transformed data to the provider 20. The provider 20 stores the data into the database 22 for future manipulation.

The client 10 can transform the data format of some data in the database 12 by the data transformation interface 11 (i.e., transform the data format into the one used by the virtual data processor 30) and send the transformed data to the virtual data processor 30. The virtual data processor will store them in the database 31. Therefore, when the provider 20 needs the data, he or she can obtain them from the database 3 in the virtual data processor 30 (of course, the data format should be transformed). On the other hand, the provider 20 can transform the data format of some data in the database 22 by the data transformation interface 21 (i.e., transform the data formation into the one used by the virtual data processor 30) and send the transformed data to the virtual data processor 30. The virtual data processor will store them in the database 31. Hence, when the client 10 needs the data, he or she can obtain them from the database 31 in the virtual data processor 30 (of course, the data format should be transformed). For example, the client 10 and the provider 20 can store the inventory data in the database 31 in the virtual data processor 30. The client 10 and the provider 20 can estimate their inventory according to the inventory data stored in the database 31 in the virtual data processor 30. As a result, it will not increase the estimation of the inventory, and hence, will not increase the costs.

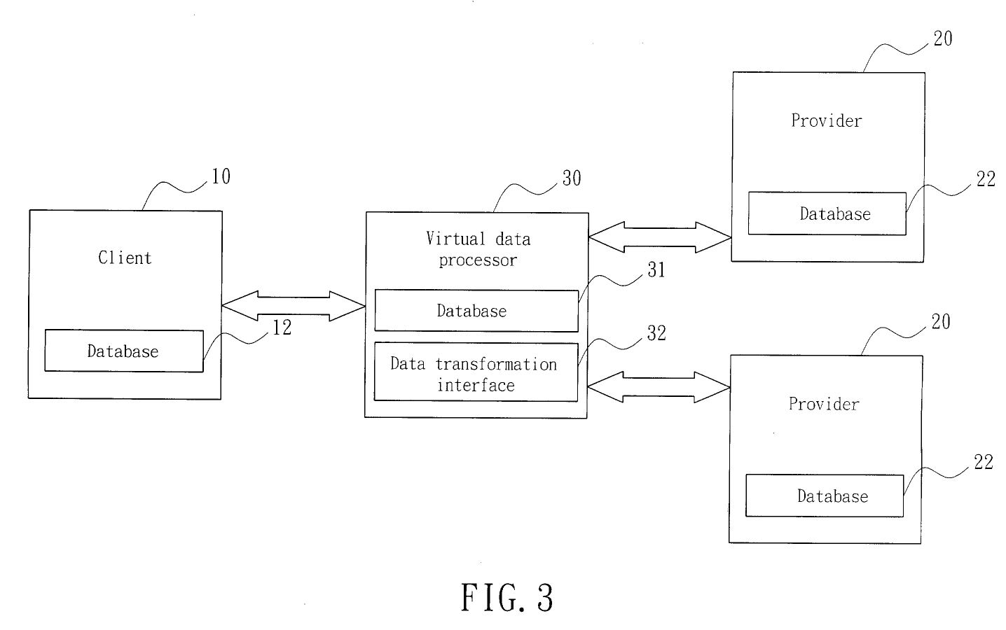

FIG. 3 shows another embodiment of the invention transmitting the data via World Wide Web. The system comprises the client 10, multiple providers 20 and the virtual data processor 30. The client 10 and the providers 20 connect with the virtual data processor 30, and each of them contains a database 12,22,31 to store the data. In the virtual data processor 30, there is a data transformation interface 32 to transform the data format.

When the client 10 wants to send the data in the database 12 to the provider 20, the data format will be transformed to the one used by the virtual data processor 30 by the data transformed interface 32 in the virtual data processor 30. The virtual data processor stores the data in its database 31, transforms the data format into the one used by the provider 20, and sends the transformed data to the provider 20. The provider 20 then stores the data in his or her database 22.

The client 10 can send the data from his or her database 12 to the virtual data processor 30. The virtual data processor transforms the data format into the one used by the virtual data processor 30 by the data transformation interface 32 in the virtual data processor 30 and stores the transformed data in the database 31. Therefore, when the provider 20 needs the data, he or she can obtain them from the database 31 in the virtual data processor 30 (of course, the data format should be transformed). On the other hand, the provider 20 can send the data from his or her database 22 to the virtual data processor 30. The virtual data processor transforms the data format into the one used by the virtual data processor 30 by the data transformation interface 32 in the virtual data processor 30 and stores the transformed data in the database 31. Hence, when the client 10 needs the data, he or she can obtain them from the database 31 in the virtual data processor 30 (of course, the data format should be transformed). For example, the client 10 and the provider 20 can store the inventory data in the database 31 in the virtual data processor 30. The client 10 and the provider 20 can estimate their inventory according to the inventory data stored in the database 31 in the virtual data processor 30. As a result, it will not increase the estimation of the inventory, and hence, will not increase the cost.

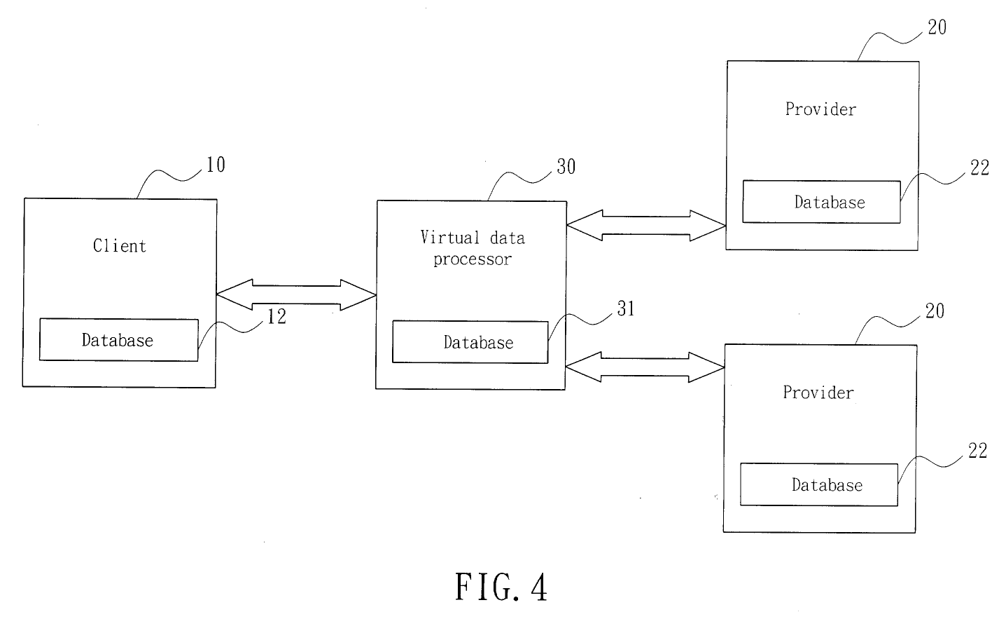

FIG. 4 shows another embodiment of the invention transmitting the data via World Wide Web. The system comprises the client 10, multiple providers 20 and the virtual data processor 30. The client 10 and the providers 20 connect with the virtual data processor 30, and each of them contains a database 12,22,31 to store the data. In the virtual data processor 30, there is a data transformation interface 32 to transform the data format. When the employed software of the client and the provider are the same, the client can send the data from his or her database 12 to the database 31 in the virtual data processor 30 without using the mentioned, data transformation interfaces 11,12. The virtual data processor 30 sends the data to the provider 20 and the provider 20 stores the data in his or her database. Likewise, the client (respectively, the provider) can store the data in the virtual data processor 30 for future requests of the provider (respectively, the client).

Expected Effects

The invention is related to a data warehouse system providing remote queries for multiple providers, and has the following effects:

1. Increasing the Operation Efficiency of the Provider and the Client.

The invention avoids transmitting the client's purchase requirements to the provider and transmitting the provider's data to the client via several tedious processes. Hence, the operation efficiency between the client and the provider increases.

2. Eliminating the Re-Key in of the Same Data of the Provider and the Client.

Since the client and the provider may use difference software, the client (respectively, the provider) cannot directly use the data of the provider (respectively, the client) and need to re-key in the data. The invention can avoid re-keying the same data by data transformation.

3. Reducing the Cost of Warehouse.

The transparency of the inventory of the client and the provider avoids over-provision or shortage of materials, and hence, the costs of material inventories of the client and the provider are reduced.

4. Reducing Manpower

Since the faults caused by manual data transmission are avoided, no extra manpower is required to handle these faults.

5. Reducing the System Complexity

Since the client and the provider only contact with one corresponding unit, the system complexity is reduced.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A data warehouse system providing remote queries for multiple providers transmitting the data via Word Wide Web, the system comprising:
a client, which comprising a database to store the data;
a plurality of providers, which comprising a database to store the data for each provider; and
a virtual data processor, which has a database for storing data and connected to the client and the multiple providers, for receiving the data from the client and the multiple providers there by storing in the database.

2. The system of claim 1, wherein the virtual data processor receives the data from the client and transmits the data to the provider.

3. The system of claim 1, wherein the virtual data processor receives the data from the provider and transmits the data to the client.

4. The system of claim 1, wherein the virtual data processor has a data transformation interface to transform the format of the data transmitted by the client and the provider before storing them.

5. The system of claim 1, wherein the client has a data transformation interface to transform the format of the data to be transmitted.

6. The system of claim 1, wherein each provider has a data transformation interface to transform the format of the data to be transmitted.
